(19) United States
(12) Patent Application Publication
(10) Pub. No.: US 2019/0331816 A1
(43) Pub. Date: Oct. 31, 2019

(54) METHOD FOR DEALIASING DATA

(71) Applicant: SEISMIC APPARITION GmbH, Pfaeffikon SZ (CH)

(72) Inventors: Fredrik Andersson, Altendorf (CH); Dirk-Jan Van Manen, Otelfingen (CH); Johan Robertsson, Wald (CH); Jens Wittsten, Loddekopinge (SE); Kurt Eggenberger, Schinznach (CH)

(73) Assignee: SEISMIC APPARITION GmbH, Pfaeffikon SZ (CH)

(21) Appl. No.: 16/509,151

(22) Filed: Jul. 11, 2019

Related U.S. Application Data
(63) Continuation of application No. PCT/IB2018/050034, filed on Jan. 3, 2018.

(30) Foreign Application Priority Data
Jan. 12, 2017 (GB) 1700520.8

(51) Int. Cl. G01V 1/36

(52) U.S. Cl. CPC G01V 1/362; G01V 2210/57; G01V 2210/56

(57) ABSTRACT

A method is disclosed for separating the unknown contributions of one or more sources from a commonly acquired set of wavefield signals using analytic properties of complex and hypercomplex representations. In particular, the methods are designed to treat the case where the wavefield consists of seismic sources and of sets of aliased recorded and/or aliased processed seismic signals.

### FIELD

The present disclosure relates to methods for dealiasing data such as encountered when acquiring and separating contributions from two or more different simultaneously emitting sources in a common set of measured signals representing a wavefield, particularly of seismic sources and of sets of aliased recorded and/or aliased processed seismic signals.

### BACKGROUND

Seismic data can be acquired in land, marine, seabed, transition zone, and boreholes, for instance. Depending on in what environment the seismic survey is taking place, the survey equipment and acquisition practices will vary.

In towed marine seismic data acquisition, a vessel tows streamers that contain seismic sensors (hydrophones and sometimes particle motion sensors). A seismic source usually towed by the same vessel excites acoustic energy in the water that reflects from the sub-surface and is recorded by the sensors in the streamers. The seismic source is typically an array of airguns but can also be a marine vibrator for instance. In modern marine seismic operations many streamers are towed behind the vessel and the vessel sails, e.g., many parallel closely spaced sail-lines (3D seismic data acquisition). It is also common that several source and/or receiver vessels are involved in the same seismic survey in order to acquire data that is rich in offsets and azimuths between source and receiver locations.

In seabed seismic data acquisition, nodes or cables containing sensors (hydrophones and/or particle motion sensors) are deployed on the seafloor. These sensors can also record the waves on and below the sea bottom and in particular shear waves which are not transmitted into the water. Similar sources as in towed marine seismic data acquisition are used. The sources are towed by one or several source vessels.

In land seismic data acquisition, the sensors on the ground are typically geophones and the sources are vibroseis trucks or dynamite. Vibroseis trucks are usually operated in arrays with two or three vibroseis trucks emitting energy close to each other roughly corresponding to the same shot location.

The general practice of marine and seabed seismic surveying is further described below in relation to FIG. 16.

Prospecting for subsurface hydrocarbon deposits (1601) in a marine environment (FIG. 16) is routinely carried out using one or more vessels (1602) towing seismic sources (1603-1605). The one or more vessels can also tow receivers or receivers (1606-1608) can be placed on the seabed (1614).

Seismic sources typically employ a number of so-called airguns (1609-1611) which operate by repeatedly filling up a chamber in the gun with a volume of air using a compressor and releasing the compressed air at suitable chosen times (and depth) into the water column (1612).

The sudden release of compressed air momentarily displaces the seawater, imparting its energy on it, setting up an impulsive pressure wave in the water column propagating away from the source at the speed of sound in water (with a typical value of around 1500 m/s) (1613).

Upon incidence at the seafloor (or seabed) (1614), the pressure wave is partially transmitted deeper into the subsurface as elastic waves of various types (1615-1617) and partially reflected upwards (1618). The elastic wave energy propagating deeper into the subsurface partitions whenever discontinuities in subsurface material properties occur. The elastic waves in the subsurface are also subject to an elastic attenuation which reduces the amplitude of the waves depending on the number of cycles or wavelengths.

Some of the energy reflected upwards (1620-1621) is sensed and recorded by suitable receivers placed on the seabed (1606-1608), or towed behind one or more vessels. The receivers, depending on the type, sense and record a variety of quantities associated with the reflected energy, for example, one or more components of the particle displacement, velocity or acceleration vector (using geophones, mems [micro-electromechanical] or other devices, as is well known in the art), or the pressure variations (using hydrophones). The wave field recordings made by the receivers are stored locally in a memory device and/or transmitted over a network for storage and processing by one or more computers.

Waves emitted by the source in the upward direction also reflect downward from the sea surface (1619), which acts as a nearly perfect mirror for acoustic waves.

One seismic source typically includes one or more airgun arrays (1603-1605): that is, multiple airgun elements (1609-1611) towed in, e.g., a linear configuration spaced apart several meters and at substantially the same depth, whose air is released (near-) simultaneously, typically to increase the amount of energy directed towards (and emitted into) the subsurface.

Seismic acquisition proceeds by the source vessel (1602) sailing along many lines or trajectories (1622) and releasing air from the airguns from one or more source arrays (also known as firing or shooting) once the vessel or arrays reach particular pre-determined positions along the line or trajectory (1623-1625), or, at fixed, pre-determined times or time intervals. In FIG. 16, the source vessel (1602) is shown in three consecutive positions (1623-1625), also called shot positions.

Typically, subsurface reflected waves are recorded with the source vessel occupying and shooting hundreds of shots positions. A combination of many sail-lines (1622) can form, for example, an areal grid of source positions with associated inline source spacings (1626) and crossline source spacings. Receivers can be similarly laid out in one or more lines forming an areal configuration with associated inline receiver spacings (1627) and crossline receiver spacings.

The general practice of land seismic surveying is further described below in relation to FIG. 17.

Prospecting for subsurface hydrocarbon deposits (1701) in a land environment (FIG. 17) is routinely carried out using one or more groups of so-called seismic vibrators (1702-1705) or other sources such as shotpipes or dynamite (not shown). Seismic vibrators transform energy provided by, e.g., a diesel engine into a controlled sequence of vibrations that radiate away from the vibrator as elastic waves (1706). More specifically, elastic waves emanate from a baseplate (1707), connected to a movable element whose relative motion realizes the desired vibrations through a piston-reaction mass system driven by an electrohydraulic servo valve. The baseplate (1707) is applied to the ground for each vibration, then raised up so that the seismic vibrator can drive to another vibrating point (indicated by solid markers such as triangles, circles, squares and pentagons in FIG. 17). To transmit maximum force into the ground and to prevent the baseplate from jumping, part of the weight of the vibrator is used to hold down the baseplate.

Thus, one group of seismic sources could consist of the “array” of vibrators 1702 and 1703, while a second group of sources consists, e.g., of vibrators 1704 and 1705.

The elastic waves radiating away from the baseplate of the vibrators scatter, reflect (1708) and refract (1709) at locations or interfaces in the subsurface where the relevant material properties (e.g., mass density, bulk modulus, shear modulus) vary and are recorded at hundreds of thousand of individual/single sensors (1710) or at thousands of sensor groups (1711). Sensor signals from one or more sensors in a group can be combined or summed in the field before being sent sent to the recording truck (1712) over cables or wirelessly.

Source positions may lie along straight lines (1714) or various other trajectories or grids. Similarly, receiver positions may lay along lines oriented in a similar direction as the source lines, e.g., 1720, and/or oriented perpendicularly to the source lines (1721). Receivers may also be laid out along other trajectories or grids. The source spacing along the line (1715) is the distance the source in a group move between consecutive shotpoints. The inter source spacing (1716) is the distance between two sources in the same source group. Similarly, the receiver spacing is the spacing between individual receivers (e.g., 1718) in case single sensors or between sensor groups (e.g., 1717). The source line spacing (1719) is some representative distance between substantially parallel source lines and similarly for the receiver line spacing. Waves may be affected by perturbations in the near surface (1713) which obscure the deeper structure of interest (i.e., possible hydrocarbon bearing formations).

In land seismic data acquisition, the sensors on the ground are typically geophones.

Traditionally seismic data have been acquired sequentially: a source is excited over a limited period of time and data are recorded until the energy that comes back has diminished to an acceptable level and all reflections of interest have been captured after which a new shot at a different shot location is excited. Being able to acquire data from several sources at the same time is clearly highly desirable. Not only would it allow to cut expensive acquisition time drastically or to better sample the wavefield on the source side which typically is much sparser sampled than the distribution of receiver positions. It would also allow for better illumination of the target from a wide range of azimuths as well as to better sample the wavefield in areas with surface obstructions. In addition, for some applications such as 3D VSP acquisition, or marine seismic surveying in environmentally sensitive areas, reducing the duration of the survey is critical to save cost external to the seismic acquisition itself (e.g., down-time of a producing well) or minimize the impact on marine life (e.g., avoiding mating or spawning seasons of fish species).

Simultaneously emitting sources, such that their signals overlap in the (seismic) record, is also known in the industry as “blending”. Conversely, separating signals from two or more simultaneously emitting sources is also known as “deblending” and the data from such acquisitions as “blended data”.

Simultaneous source acquisition has a long history in land seismic acquisition dating back at least to the early 1980's. Commonly used seismic sources in land acquisition are vibroseis sources which offer the possibility to design source signal sweeps such that it is possible to illuminate the sub-surface “sharing” the use of certain frequency bands to avoid simultaneous interference at a given time from different sources. By carefully choosing source sweep functions, activation times and locations of different vibroseis sources, it is to a large degree possible to mitigate interference between sources. Such approaches are often referred to as slip sweep acquisition techniques. In marine seismic data context the term overlapping shooting times is often used for related practices. Moreover, it is also possible to design sweeps that are mutually orthogonal to each other (in time) such that the response from different sources can be isolated after acquisition through simple cross-correlation procedures with sweep signals from individual sources. We refer to all of these methods and related methods as “time encoded simultaneous source acquisition” methods and “time encoded simultaneous source separation” methods.

The use of simultaneous source acquisition in marine seismic applications is more recent as marine seismic sources (i.e., airgun sources) do not appear to yield the same benefits of providing orthogonal properties as land seismic vibroseis sources, at least not at a first glance. Western Geophysical was among the early proponents of simultaneous source marine seismic acquisition suggesting to carry out the separation in a pre-processing step by assuming that the reflections caused by the interfering sources have different characteristics. Beasley et al. (1998) exploited the fact that, provided that the sub-surface structure is approximately layered, a simple simultaneous source separation scheme can be achieved for instance by having one source vessel behind the spread acquiring data simultaneously with the source towed by the streamer vessel in front of the spread. Simultaneous source data recorded in such a fashion is straightforward to separate after a frequency-wavenumber (ωξ) transform as the source in front of the spread generates data with positive wavenumbers only whereas the source behind the spread generates data with negative wavenumbers only, to first approximation.

Another method for enabling or enhancing separability is to make the delay times between interfering sources incoherent (Lynn et al., 1987). Since the shot time is known for each source, they can be lined up coherently for a specific source in for instance a common receiver gather or a common offset gather. In such a gather all arrivals from all other simultaneously firing sources will appear incoherent. To a first approximation it may be sufficient to just process the data for such a shot gather to final image relying on the processing chain to attenuate the random interference from the simultaneous sources (aka. passive separation). However, it is of course possible to achieve better results for instance through random noise attenuation or more sophisticated methods to separate the coherent signal from the apparently incoherent signal (Stefani et al., 2007; Ikelle 2010; Kumar et al. 2015). In recent years, with elaborate acquisition schemes to for instance acquire wide azimuth data with multiple source and receiver vessels (Moldoveanu et al., 2008), several methods for simultaneous source separation of such data have been described, for example methods that separate “random dithered sources” through inversion exploiting the sparse nature of seismic data in the time-domain (i.e., seismic traces can be thought of as a subset of discrete reflections with “quiet periods” in between; e.g., Akerberg et al., 2008; Kumar et al. 2015). A recent state-of-the-art land example of simultaneous source separation applied to reservoir characterization is presented by Shipilova et al. (2016). Existing simultaneous source acquisition and separation methods based on similar principles include quasi random shooting times, and pseudo random shooting times. We refer to all of these methods and related methods as “random dithered source acquisition” methods and “random dithered source separation” methods. “Random dithered source acquisition” methods and “random dithered source separation” methods are examples of “space encoded simultaneous source acquisition” methods and “space encoded simultaneous source separation” methods.

A different approach to simultaneous source separation has been to modify the source signature emitted by airgun sources. Airgun sources comprise multiple (typically three) sub-arrays along which multiple clusters of smaller airguns are located. Whereas in contrast to land vibroseis sources, it is not possible to design arbitrary source signatures for marine airgun sources, one in principle has the ability to choose firing time (and amplitude i.e., volume) of individual airgun elements within the array. In such a fashion it is possible to choose source signatures that are dispersed as opposed to focused in a single peak. Such approaches have been proposed to reduce the environmental impact in the past (Ziolkowski, 1987) but also for simultaneous source shooting.

Abma et al. (2015) suggested to use a library of “popcorn” source sequences to encode multiple airgun sources such that the responses can be separated after simultaneous source acquisition by correlation with the corresponding source signatures following a practice that is similar to land simultaneous source acquisition. The principle is based on the fact that the cross-correlation between two (infinite) random sequences is zero whereas the autocorrelation is a spike. It is also possible to choose binary encoding sequences with better or optimal orthogonality properties such as Kasami sequences to encode marine airgun arrays (Robertsson et al., 2012). Mueller et al. (2015) propose to use a combination of random dithers from shot to shot with deterministically encoded source sequences at each shot point. Similar to the methods described above for land seismic acquisition we refer to all of these methods and related methods as “time encoded simultaneous source acquisition” methods and “time encoded simultaneous source separation” methods.

Recently there has been an interest in industry to explore the feasibility of marine vibrator sources as they would, for instance, appear to provide more degrees of freedom to optimize mutually orthogonal source functions beyond just binary orthogonal sequences that would allow for a step change in simultaneous source separation of marine seismic data. Halliday et al. (2014) suggest to shift energy in ωk-space using the well-known Fourier shift theorem in space to separate the response from multiple marine vibrator sources. Such an approach is not possible with most other seismic source technology (e.g., marine airgun sources) which lack the ability to carefully control the phase of the source signature (e.g., flip polarity).

A recent development, referred to as “seismic apparition” (also referred to as signal apparition or wavefield apparition in this invention), suggests an alternative approach to deterministic simultaneous source acquisition that belongs in the family of “space encoded simultaneous source acquisition” methods and “space encoded simultaneous source separation” methods. Robertsson et al. (2016) show that by using periodic modulation functions from shot to shot (e.g., a short time delay or an amplitude variation from shot to shot), the recorded data on a common receiver gather or a common offset gather will be deterministically mapped onto known parts of for instance the ωξ-space outside the conventional “signal cone” where conventional data is strictly located (FIG. 1a). The signal cone contains all propagating seismic energy with apparent velocities between water velocity (straight lines with apparent slowness of +− 1/1500 s/m in ωξ-space) for the towed marine seismic case and infinite velocity (i.e., vertically arriving events plotting on a vertical line with wavenumber 0). The shot modulation generates multiple new signal cones that are offset along the wavenumber axis thereby populating the ωξ-space much better and enabling exact simultaneous source separation below a certain frequency (FIG. 1b). Robertsson et al. (2016) referred to the process as “wavefield apparition” or “signal apparition” in the meaning of “the act of becoming visible”. In the spectral domain, the wavefield caused by the periodic source sequence is nearly “ghostly apparent” and isolated. A critical observation and insight in the “seismic apparition” approach is that partially injecting energy along the ωξ-axis is sufficient as long as the source variations are known as the injected energy fully predicts the energy that was left behind in the “conventional” signal cone. Following this methodology simultaneously emitting sources can be exactly separated using a modulation scheme where for instance amplitudes and or firing times are varied deterministically from shot to shot in a periodic pattern. It is herein proposed to make use of properties of analytic functions for complex representations, and corresponding structures for hypercomplex representations, to separate simultaneous source data acquired using seismic apparition into separate source contributions. Moreover, the technique can also be used to reduce the effects of aliasing due to limitations in sampling. Further novel methods to reduce aliasing have been submitted in van Manen et al. (2016b.

### SUMMARY

Methods for dealiasing recorded wavefield information making use of a non-aliased representation of a part of the recorded wavefield, and a phase factor derived from a representation of a non-aliased part of the wavefield, and combining both to a non-aliased function from which the further parts of the recorded wavefield information can be gained, suited particularly for seismic applications and other purposes, substantially as shown in and/or described in connection with at least one of the figures, and as set forth more completely in the claims.

In particular, the present disclosure provides a method of dealiasing recorded wavefield information recorded at a first sampling interval, the method comprising: forming an analytic part of the recorded wavefield information; extracting a non-aliased representation of a portion of the recorded wavefield information; forming a phase factor from a conjugate part of the analytic part of the non-aliased representation; combining the analytic part of the recorded wavefield information with the phase factor to derive a non-aliased function; applying a filtering operation to the derived non-aliased function; recombining the filtered non-aliased function with the phase factor from the analytic part of the non-aliased representation to reconstruct a representation of dealiased recorded wavefield information; generating a sub-surface representation of structures or Earth media properties from the reconstructed representation of the dealiased recorded wavefield information; and outputting the generated sub-surface representation.

Advantages, aspects and novel features of the present disclosure, as well as details of an illustrated embodiment thereof, may be more fully understood from the following description and drawings.

### BRIEF DESCRIPTION OF THE DRAWINGS

In the following description reference is made to the attached figures, in which:

FIG. 1 illustrates how in a conventional marine seismic survey all signal energy of two sources typically sits inside a “signal cone” (horizontally striped) bounded by the propagation velocity of the recording medium and how this energy can be split in a transform domain by applying a modulation to the second source;

FIG. 2 shows a common-receiver gather from the simultaneous source complex salt data example with all four sources firing simultaneously in the reference frame of the firing time of sources 1 and 2 in the Fourier domain;

FIG. 3 shows filtered blended data in the Fourier domain corresponding to the data set depicted in FIG. 1. The data clearly contains a mixture from two directions;

FIG. 4 shows phase shifted data in the Fourier domain corresponding to the data set depicted in FIG. 2. Note how the energy from the two parts is moved into two centers;

FIG. 5 shows the filtered reconstruction of source one in the Fourier domain corresponding to the data set depicted in FIGS. 1-3;

FIG. 6 shows a common-receiver gather from the simultaneous source complex salt data example with all four sources firing simultaneously in the reference frame of the firing time of sources 1 and 2 in the quaternion Fourier domain. Note that all energy is present in one quadrant;

FIG. 7 shows filtered blended data in the quaternion Fourier domain corresponding to the data set depicted in FIG. 6. The data clearly contains a mixture from two directions;

FIG. 8 shows phase shifted data in the quaternion Fourier domain corresponding to the data set depicted in FIG. 6. Note how some of the energy is moved into the center and some of the energy remain unaffected. The unaffected energy corresponds only to the (shifted) information of source two;

FIG. 9 shows the filtered reconstruction of source one in the quaternion Fourier domain for source one corresponding to the data set depicted in FIGS. 5-7;

FIG. 10 shows a common-receiver gather from the simultaneous source complex salt data example with all four sources firing simultaneously in the reference frame of the firing time of sources 1 and 2 in the time domain;

FIG. 11 shows the contribution from source one only for FIG. 10 in the time domain;

FIG. 12 shows the reconstruction of source one as depicted in FIG. 11 using analytic part dealiasing in the time domain;

FIG. 13 shows the reconstruction error between the wavefield shown in FIGS. 11-12 using analytic part dealiasing in the time domain;

FIG. 14 shows the reconstruction of source one as depicted in FIG. 11 using quaternion dealiasing in the time domain;

FIG. 15 shows the reconstruction error between the wavefield shown in FIG. 11 and FIG. 14 using quaternion part dealiasing in the time domain;

FIG. 16 shows the general practice of marine seismic surveying;

FIG. 17 shows the general practice of land seismic surveying;

FIG. 18 summarizes key steps for one embodiment of the methods disclosed herein; and

FIG. 19 illustrates how the methods herein may be computer-implemented using a computer system including processing circuitry.

### DETAILED DESCRIPTION

The following examples may be better understood using a theoretical overview and its application to simultaneous source separation as presented below.

It should be understood that the same methods can be applied to the dealiasing of any wavefield in which a non-aliased content can be identified.

The method of seismic apparition (Robertsson et al., 2016) allows for exact simultaneous source separation given sufficient sampling along the direction of spatial encoding (there is always a lowest frequency below which source separation is exact). It is the only exact method there exists for conventional marine and land seismic sources such as airgun sources and dynamite sources. However, the method of seismic apparition requires good control of firing times, locations and other parameters. Seismic data are often shot on position such that sources are triggered exactly when they reach a certain position. If a single vessel tows multiple sources acquisition fit for seismic apparition is simply achieved by letting one of the sources be a master source which is shot on position. The other source(s) towed by the same vessel then must fire synchronized in time according to the firing time of the first source. However, as all sources are towed by the same vessel the sources will automatically be located at the desired positions—at least if crab angles are not too extreme. In a recent patent application (van Manen et al., 2016a) we submitted methods that demonstrate how perturbations introduced by, e.g., a varying crab angle can be dealt with in an apparition-based simultaneous source workflow. The same approach can also be used for simultaneous source separation when sources are towed by different vessels or in land seismic acquisition. Robertsson et al. (2016b) suggest approaches to combine signal apparition simultaneous source separation with other simultaneous source separation methods.

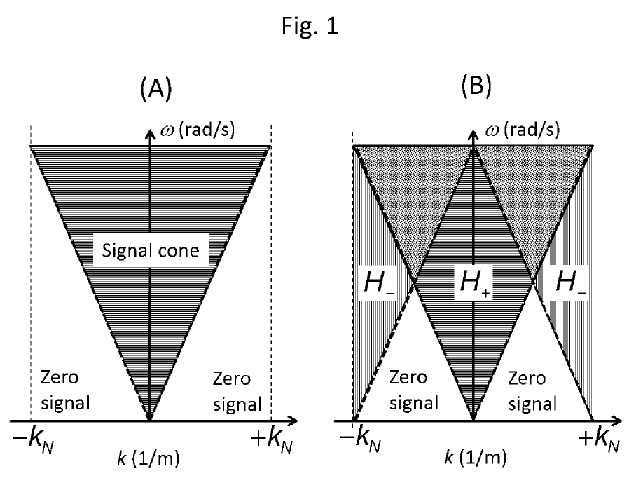

FIG. 1(B) also illustrates a possible limitation of signal apparition. The injected part of the wavefield is separated from the wavefield in the original location centered at wavenumber k=0 within the respective lozenge-shaped regions in FIG. 1(B). In the triangle-shaped parts they interfere due to aliasing and may no longer be separately predicted without further assumptions. In the example shown in FIG. 1(B), it can therefore be noted that the maximum non-aliased frequency for a certain spatial sampling is reduced by a factor of two after applying signal apparition. Assuming that data are adequately sampled, the method nevertheless enables full separation of data recorded in wavefield experimentation where two source lines are acquired simultaneously.

We will use the notation

$$\hat{f} ( ξ ) = {\int }_{- ∞}^{∞} f ( x ) {e}^{- 2 π ix ξ} dx$$

for the Fourier transform.

Let [symbol] denote the cone [symbol] ={(Ω,ξ):|ω|>|ξ|}, and let [symbol] denote the non-aliased (diamond shaped) set [symbol] = [symbol] \({(ω,ξ):|ω|>|ξ−½|}∪{(ω,ξ):|ω|>|ξ+½|}).

Suppose that

d(t,j)=ƒ₁(t,j)+ƒ₂(t−Δₜ(−1)^{j},j) (1)

is a known discrete sampling in x=j recorded at a first sampling interval. Note that due to this type of apparition sampling, the data d will always have aliasing effects present if the data is band unlimited in the temporal frequency direction.

If ƒ₁ and ƒ₂ represent seismic data recorded at a certain depth, it will hold that supp(\hat{ƒ}₁)⊂ [symbol] and supp(\hat{ƒ}₂)⊂ [symbol] . We will assume that the source locations of ƒ₁ and ƒ₂ are relatively close to each other. Let

$${D}_{1} ( ω , ξ ) = {\int }_{- ∞}^{∞} {\sum }_{j = - ∞}^{∞} d ( t , j ) {e}^{- 2 π i ( j ξ + t ω )} dt$$

$$and$$

$${D}_{2} ( ω , ξ ) = {\int }_{- ∞}^{∞} {\sum }_{j} d ( t + {{Δ}_{t} ( - 1 )}^{j} , j ) {e}^{- 2 π i ( j ξ + t ω )} dt .$$

It is shown in Andersson 2016 that

$${D}_{1} ( ω , ξ ) = {\sum }_{k = - {∞}_{{\hat{f}}_{1}}}^{∞} ( ω , ξ + k ) + {\sum }_{k = - {∞}_{{\hat{f}}_{2}}}^{∞} ( ω , ξ + \frac{k}{2} ) \frac{1}{2} ( {e}^{- 2 π i {Δ}_{t} ω} + {( - 1 )}^{k} {e}^{2 π i {Δ}_{t} ω} ) . \qquad ( 2 )$$

For each pair of values (ω,ξ)∈ [symbol] , most of the terms over k in (2) vanish (and similarly for D₂), which implies that \hat{ƒ}₁(ω, ξ) and \hat{ƒ}₂(ω,ξ) can be recovered through

$$\begin{matrix}{\hat{f}}_{1} ( ω , ξ ) = \frac{{D}_{1} ( ω , ξ ) - cos ( 2 π {Δ}_{t} ω ) {D}_{2} ( ω , ξ )}{{sin}^{2} ( 2 π {Δ}_{t} ω )} , \\ {\hat{f}}_{2} ( ω , ξ ) = \frac{{D}_{2} ( ω , ξ ) - cos ( 2 π {Δ}_{t} ω ) {D}_{1} ( ω , ξ )}{{sin}^{2} ( 2 π {Δ}_{t} ω )} ,\end{matrix} \qquad ( 3 )$$

given that sin(2πΔₜω)≠0.

By including an amplitude variation in (1), the last condition can be removed. For values of (ω,ξ)∉ [symbol] it is not possible to determine the values of \hat{ƒ}₁(ω,ξ) and \hat{ƒ}₂(ω,ξ) without imposing further conditions on the data.

Given a real valued function ƒ with zero average, let

ƒ^{a}(t)=2∫₀^{∞}∫_{-∞}^{∞}ƒ(t′)e^{2πi(t-t′)ω}dt′dω.

The quantity is often referred to as the analytic part of ƒ, a description that is natural when considering Fourier series expansions in the same fashion and comparing these to power series expansions of holomorphic functions. It is readily verified that Re(ƒ^{a})=ƒ.

As an illustrative example, consider the case where

ƒ(t)=cos(2πt)

for which it holds that

ƒ^{a}(t)=e^{2πit}.

Now, whereas |ƒ(t)| is oscillating, |ƒ^{a}(t)|=1, i.e., it has constant amplitude. In terms of aliasing, it can often be the case that a sampled version of |ƒ^{a}| exhibits no aliasing even if ƒ and |ƒ| do so.

Let us now turn our focus back to the problem of recovering \hat{ƒ}₁(ω,ξ) and \hat{ƒ}₂(ω,ξ) for (ω,ξ)∉ [symbol] . We note that due to linearity, it holds that

d^{a}(t,j)=ƒ₁^{a}(t,j)+ƒ₂^{a}(t−Δₜ(−1)^{j},j).

A natural condition to impose is that the local directionality is preserved through the frequency range. The simplest such case is when ƒ₁ and ƒ₂ are plane waves (with the same direction), i.e, when

ƒ₁(t,x)=h₁(t+bx), and ƒ₂(t,x)=h₂(t+bx).

Without loss of generality, we assume that b>0. We note that

$${\hat{f}}_{1} ( ω , ξ ) = {\int }_{- ∞}^{∞} {\int }_{- ∞}^{∞} {h}_{1} ( t + bx ) {e}^{- 2 π i ( t ω + x ξ )} dtdx = \{ s = t + bx \} = {\int }_{- ∞}^{∞} {\int }_{- ∞}^{∞} {h}_{1} ( s ) {e}^{- 2 π i ( s ω + x ( ξ - b ω )} dsdx = \hat{{h}_{1}} ( ω ) δ ( ξ - b ω ) .$$

A similar formula holds for \hat{ƒ}₂.

Let us now assume that ω<½. Inspecting (2) we see that if, e.g., −½<ξ<0 then all but three terms disappear and therefore the blended data satisfies

$$\hat{{d}^{a}} ( ω , ξ ) = ( \hat{{h}_{1}^{a}} ( ω ) + cos ( 2 {πΔ}_{t} ω ) \hat{{h}_{2}^{a}} ( ω ) ) δ ( ξ - b ω ) - i sin ( 2 {πΔ}_{t} ω ) \hat{{h}_{2}^{a}} ( ω ) δ ( ξ - ( b ω - 1 / 2 ) ) = {\hat{h}}_{1} ( ω ) δ ( ξ - b ω ) + {\hat{h}}_{2} ( ω ) δ ( ξ - ( b ω - 1 / 2 ) ) .$$

Let wₕ and wₗ be two filters (acting on the time variable) such that wₕ has unit L² norm, and such that wₕ has a central frequency of ω₀ and wₗ has a central frequency of ω₀/2. For the sake of transparency let wₕ=w²ₗ. Suppose that we have knowledge of \hat{ƒ}₁(ω,ξ) and \hat{ƒ}₂(ω,ξ) for ω<ω₀, and that the bandwidth of wₗ is smaller than ω₀/2.

Let g₁=ƒ₁^{a}*wₗ and g₂=ƒ₂^{a}*wₗ. Note that, e.g.,

g₁(t,x)=h₁^{a}*wₗ(t+bx),

so that g₁ is a plane wave with the same direction as ƒ₁. Moreover, |g₁| will typically be mildly oscillating even when ƒ₁ and |ƒ₁| are oscillating rapidly.

Let

$${p}_{1} = \frac{{g}_{1}}{\vert {g}_{1} \vert}$$

be the phase function associated with g₁, and define p₂ in a likewise manner as phase function for g₂. If wₗ is narrowbanded, g₁ will essentially only contain oscillations of the form

$${\hat{h}}_{1} ( \frac{{ω}_{0}}{2} ) {e}^{2 π i \frac{{ω}_{0}}{2} ( t + bx )}$$

i.e., |g₁(t,x)| is more or less constant.

Under the narrowband assumption on wₗ (and the relation wₕ=w²ₗ), we consider

$${d}_{h} ( t , x ) = ( {d}^{a} * {w}_{h} ) ( t , x ) \approx {h}_{1} ( {ω}_{0} ) {e}^{2 π i {ω}_{0} ( t + bx )} + {h}_{2} ( {ω}_{0} ) {e}^{2 π i ( {ω}_{0} t + ( b {ω}_{0} - 1 ) x )} .$$

By multiplication by p̅₁̅p̅₂̅, which may be considered as an example of a conjugated phase factor, we get

dₕ(t,x)p̅₁̅(̅t̅,̅x̅)̅p̅₂̅(̅t̅,̅x̅)̅≈h₁(ω₀)+h₂(ω₀)e^{-πix}. (4)

In the Fourier domain, this amounts to two delta-functions; one centered at the origin and one centered at (0,−½). Here, we may identify the contribution that comes from ƒ₂ by inspecting the coefficient in front of the delta-function centered at (0,−½). By the aid of the low-frequency reconstructions g₁ and g₂, it is thus possible to move the energy that originates from the two sources so that one part is moved to the center, and one part is moved to the Nyquist wavenumber. Note that it is critical to use the analytic part of the data to obtain this result. If the contributions from the two parts can be isolated from each other, it allows for a recovery of the two parts in the same fashion as in (3). Moreover, as the data in the isolated central centers is comparatively oversampled, a reconstruction can be obtained at a higher resolution than the original data. Afterwards, the effect of the phase factor can easily be reversed, and hence a reconstruction at a finer sampling, i.e. at a smaller sampling interval than the original can be obtained.

A similar argument will hold in the case when the filters wₗ and wₕ have broader bandwidth. By making the approximation that

p₁(t,x)≈e^{πiω}^{₀}^{(t+bx)}

we get that

$${d}_{h} ( t , x ) \overline{{p}_{1} ( t , x ) {p}_{2} ( t , x )} \approx {h}_{1} ( ω ) {e}^{2 π i ( ω - {ω}_{0} ) ( t + bx )} + {h}_{2} ( ω ) {e}^{- π ix + {e}^{2 π i ( ω - {ω}_{0} ) ( t + bx )}} ,$$

and since wₕ is a bandpass filter, \hat{d}ₕ(ω,ξ) will contain information around the same two energy centers, where the center around (0,−½) will contain only information about ƒ₂. By suppressing such localized energy, we can therefore extract only the contribution from ƒ₂ and likewise for ƒᵢ.

The above procedure can now be repeated with ω₀ replaced by ω₁=βω₀ for some β>1. In this fashion we can gradually recover (dealias) more of the data by stepping up in frequency. We can also treat more general cases. As a first improvement, we replace the plane wave assumption by a locally plane wave assumption, i.e., let φₐ be a partition of unity (Σ_{α}φ_{α}²=1), and assume that

ƒ₁(t,x)φ_{α}²(t,x)≈h_{1,α}(t+b_{α}x)φ_{α}²(t,x).

In this case the phase functions will also be locally plane waves, and since they are applied multiplicatively on the space-time side, the effect of (4) will still be that energy will be injected in the frequency domain towards the two centers at the origin and the Nyquist wavenumber.

Now, in places where the locally plane wave assumption does not hold, the above procedure will not work. This is because as the phase function contains contributions from several directions at the same location, the effect of the multiplication in will no longer correspond to injecting the energy of D₁ (and D₂) towards the two centers around the origin and the Nyquist number. However, some of this directional ambiguity can still be resolved.

In fact, upon inspection of (2), it is clear that the energy contributions to a region with center (ω₀,ξ₀) must originate from regions with centers at (ω₀,ξ₀+k/2) for some k. Hence, the directional ambiguity is locally limited to contributions from certain directions. We will now construct a setup with filters that will make use of this fact.

Let us consider the problem where we would like to recover the information from a certain region (ω₀,ξ₀). Due to the assumption that ƒ₁ and ƒ₂ correspond to measurements that take place close to each other, we assume that ƒ₁ and ƒ₂ have similar local directionality structure. From (2) we know that energy centered at (ω₀,ξ₀) will be visible in measurements D₁ at locations (ω₀,ξ₀+k/2). We therefor construct a (space-time) filter wₕ, that satisfies

$$\hat{{w}_{h}} ( ω , ξ ) = {\sum }_{{k}_{\hat{Ψ}}} ( ω - {ω}_{0} , ξ - {ξ}_{0} - \frac{k}{2} ) . \qquad ( 5 )$$

We now want to follow a similar construction for the filter wₗ. Assuming that there is locally only a contribution from a direction associated with one of the terms over k above, we want the action of multiplying with the square of the local phase to correspond to a filtration using the part of wₕ that corresponds to that particular k.

This is accomplished by letting

$$\hat{{w}_{l}} ( ω , ξ ) = {\sum }_{{k}_{\hat{ψ}}} ( ω - \frac{{ω}_{0}}{2} , ξ - \frac{{ξ}_{0}}{2} - \frac{k}{4} ) , \qquad ( 6 )$$

where \hat{Ψ}=\hat{ψ}*\hat{ψ}.

Under the assumption that ƒ₁*wₕ and ƒ₂*wₕ has a local plane wave structure, we may now follow the above procedure to recover these parts of ƒ₁ and ƒ₂ (by suppressing localized energy as described above). We may then completely recover ƒ₁ and ƒ₂ up to the temporal frequency ω₀ by combining several such reconstructions, and hence we may proceed by making gradual reconstructions in the ω variable as before.

### Example

As an example we have applied one embodiment of the simultaneous source separation methodology presented here to a synthetic data set generated using an acoustic 3D finite-difference solver and a model based on salt-structures in the sub-surface and a free-surface bounding the top of the water layer. A common-receiver gather located in the middle of the model was simulated using this model a vessels acquiring two shotlines with an inline shot spacing of 25 meters. The vessel tows source 1 at 150 m cross-line offset from the receiver location as well as source 2 at 175 m cross-line offset from the receiver location. The source wavelet comprises a Ricker wavelet with a maximum frequency of 30 Hz.

Sources 1 and 2 towed behind Vessel A are encoded against each other using signal apparition with a modulation periodicity of 2 and a 12 ms time-delay such that Source 1 fires regularly and source 2 has a time delay of 12 ms on all even shots.

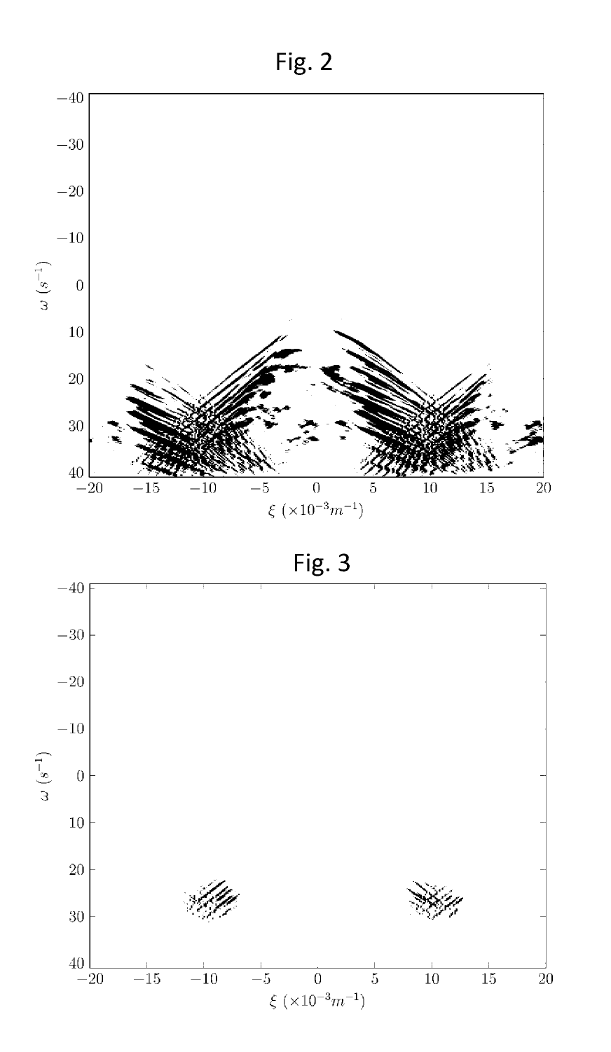

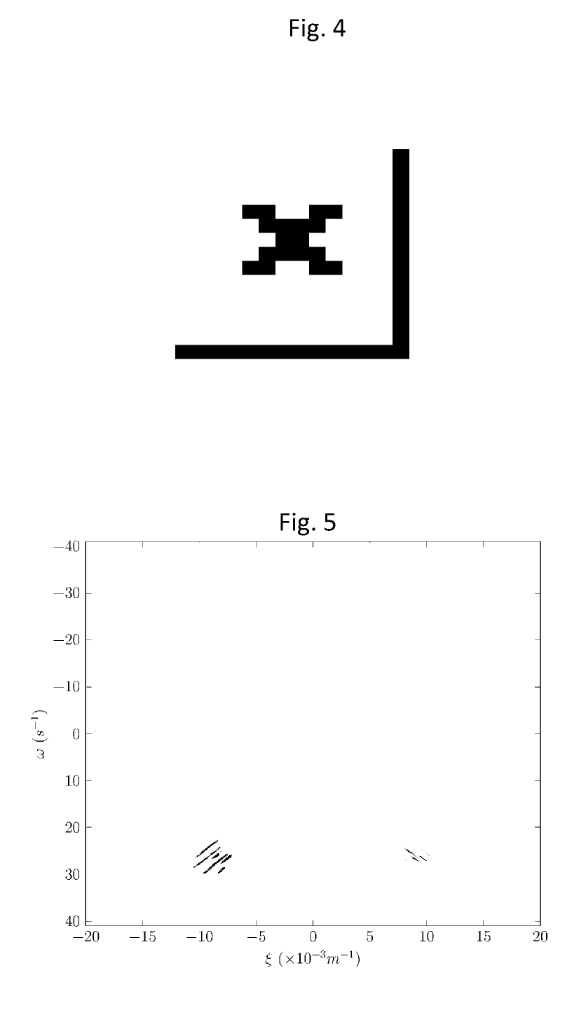

In FIGS. 2-5 the procedure as well as some results are illustrated in the frequency domain. FIG. 2 shows the Fourier transform of the blended data, and the effect of the overlap in [symbol] \ [symbol] is clearly visible. Note that the information in the central diamond shaped region can be recovered by using (3). We now need to recover the remaining part. In FIG. 3 the blended data is filtered by multiplication of ŵₕ from (5). Next, using the recovered parts of ƒ₁ and ƒ₂ we compute the phase functions using the filters from (6), and after that we apply the phase function multiplicatively in the (t,x)-domain using (4). In FIG. 4, the result is illustrated in the (ω,ξ)-domain. Finally, we isolate the two parts and use a similar reconstruction formula as (3) using a phase factor to approximately recover

(ƒ₁*wₕ)p̅₁̅p̅₂̅.

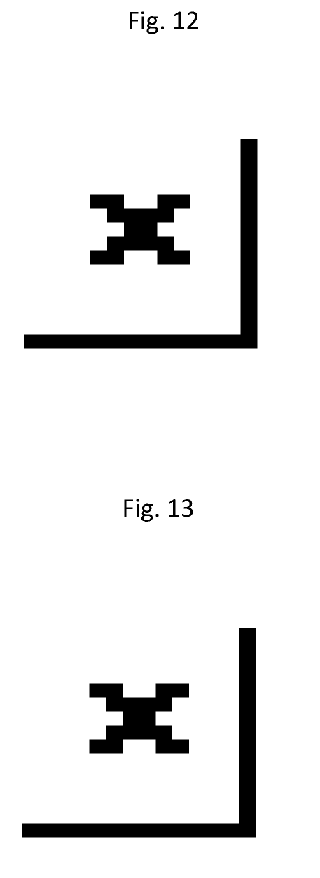

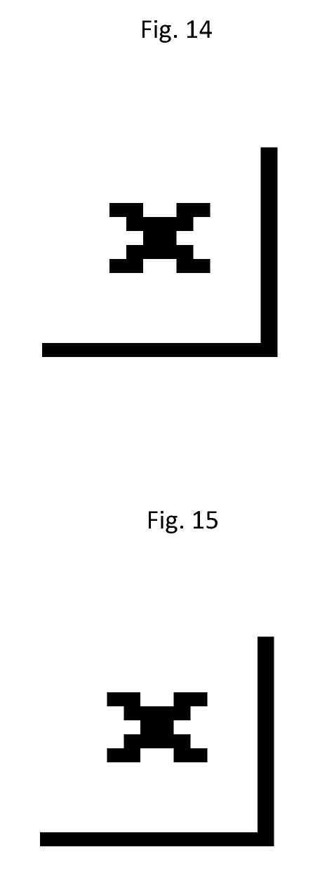

This part is expected to be well sampled since much of the oscillating parts are counteracted by the factor p̅₁̅p̅₂̅, and it can thus be resampled using a smaller trace distance, if desired. The final reconstruction is obtained by multiplication with p₁p₂, which is displayed in FIG. 5. In FIGS. 10-13 we illustrate the reconstruction in the temporal-spatial domain. FIG. 10 shows the blended data, and the apparition pattern is illustrated in the two smaller inset images. In FIG. 11 the original data from source one is shown, and in FIG. 12 the reconstruction of source one is shown. FIG. 13 finally shows the reconstruction error for source one.

In an alternative embodiment we will make use of quaternion Fourier transforms instead of standard Fourier transforms, and make use of a similar idea as for the analytic part.

Let [symbol] be the quaternion algebra (Hamilton, 1844). An element q∈ [symbol] can be represented as q=q₀+iq₁+jq₂+kq₃, where the qⱼ are real numbers and i²=j²=k²=ijk=−1. We also recall Euler's formula, valid for i,j,k:

e^{iθ}=cos θ+i sin θ, e^{jθ}=cos θ+j sin θ, e^{kθ}=cos θ+k sin θ.

Note that although i,j,k commute with the reals, quaternions do not commute in general. For example, we generally have e^{iθ}e^{jϕ}≠e^{jϕ}e^{iθ} which can easily be seen by using Euler's formula. Also recall that the conjugate of q=q₀+iq₁+j q₂+kq₃ is the element q*=q₀−iq₁−jq₂−kq₃. The norm of q is defined as ∥q∥=(qq*)^{1/2}=(q₀²+q₁²+q₂²+q₃²)^{1/2}.

Given a real valued function ƒ=ƒ(t,x), we define the quaternion Fourier transform (QFT) of ƒ by

Qƒ(ω,ξ)=∫_{-∞}^{∞}∫_{-∞}^{∞}e^{-2πitω}ƒ(t,x)e^{-2πjxξ}dtdx.

Its inverse is given by

ƒ(t,x)=Q⁻¹(Qƒ)(t,x)=∫_{-∞}^{∞}∫_{-∞}^{∞}e^{2πitω}Qƒ(ω,ξ)e^{2πjxξ}dωdξ.

In a similar fashion, it is possible to extend the Fourier transform to other hypercomplex representations, e.g., octanions (van der Blij, 1961), sedenions (Smith, 1995) or other Cayley or Clifford algebras. A similar argument applies to other well-known transform domains (e.g., Radon, Gabor, curvelet, etc.).

Let

$$χ ( ω , ξ ) = \{ \begin{matrix}4 & if ω > 0 and ξ > 0 , \\ 0 & otherwise\end{matrix} ,$$

Using χ we define ƒ^{q}: [symbol] ²→ [symbol] as

ƒ^{q}=Q⁻¹χQƒ.

We call ƒ^{q} the quaternion part of ƒ. This quantity can be seen as a generalization of the concept of analytic part. For the analytic part, half of the spectrum is redundant. For the case of quaternions, three quarters of the data is redundant.

In a similar fashion, it is possible to extend the analytic part to other hypercomplex representations, e.g., octanions (van der Blij, 1961), sedenions (Smith, 1995) or other Cayley or Clifford algebras.

The following results will prove to be important: Let ƒ (t,x)=cos u, where u=2π(at+bx)+c with a>0. If b>0 then

ƒ^{q}(t,x)=cos u+i sin u+j sin u−k cos u,

and if b<0 then

ƒ^{q}(t,x)=cos u+i sin u−j sin u+k cos u.

The result is straightforward to derive using the quaternion counterpart of Euler's formula. Note that whereas |ƒ(t,x)| is oscillating, ∥ƒ^{q}∥=\sqrt{2}, i.e., it has constant amplitude. In terms of aliasing, it can often be the case that a sampled version of ∥ƒ^{q}∥ exhibits no aliasing even if ƒ and |ƒ| do so.

Assume that ƒ(t,x)=cos(u), and that g(t,x)=cos(v), where u=2m(a₁t+b₁x)+e₁ and v=2π(a₂t+b₂x)+e₂ with a₁,a₂≥0. It then holds that

$$\overline{{g}^{q}} {f}^{q} \overline{{g}^{q}} = \{ \begin{matrix}2 ( cos ( u - 2 v ) ( 1 + k ) + sin ( u - 2 v ) ( i + j ) ) & if {b}_{1} , {b}_{2} \geq 0 , \\ 2 ( cos ( u ) ( - 1 - k ) + sin ( u ) ( i + j ) ) & if {b}_{1} \geq 0 and {b}_{2} < 0\end{matrix} ,$$

with similar expressions if b₁<0.

Let us describe how to recover \hat{ƒ}₁(ω,ξ) and \hat{ƒ}₂(ω,ξ) us the quaternion part. We will follow the same procedure as before, and hence it suffices to consider the case where ƒ₁=h₁(t+bx), ƒ₂=h₂(t+bx), with b>0, and ω<½. Let wₕ and wₗ be two (real-valued) narrowband filters with central frequencies of ω₀ and ω₀/2, respectively, as before. From (2), it now follows that

d*wₕ(t,x)≈c₁ cos(2πω₀(t+bx)+e₁)+c₂ cos(2πω₀(t+bx)+e₂),

for some coefficients c₁,c₂, and phases e₁,e₂, and with b<0.

Since ƒ₁ and ƒ₂ are known for ω=ω₀/2, we let

g₁(t,x)=ƒ₁*wₗ(t,x)≈c₃ cos(πω₀(t+bx)+e₃).

We compute the quaternion part g₁^{q} of g₁, and construct the phase function associated with it as

$${p}_{1} = \frac{{g}_{1}^{q}}{\vert {g}_{1}^{q} \vert} ,$$

and define p₂ in a likewise manner as the phase function for g₂.

Let d^{q} be the quaternion part of d*wₕ. It then holds that after a left and right multiplication of conjugate of the phase factors p₁ and p₂

$$\overline{{p}_{1}} {d}^{q} \overline{{p}_{1}} \approx {c}_{1} 2 ( cos ( {e}_{1} - 2 {e}_{3} ) ( 1 + k ) + sin ( {e}_{1} - 2 {e}_{3} ) ( i + j ) ) + {c}_{2} 2 ( cos ( 2 {πω}_{0} ( t {+}_{b} x ) + {e}_{1} ) ( - 1 - k ) + sin ( 2 {πω}_{0} ( t {+}_{b} x ) + {e}_{1} ) ( i + j ) ) .$$

This result is remarkable, since the unaliased part of d is moved to the center, while the aliased part remains intact. Hence, it allows for a distinct separation between the two contributing parts.

### Example

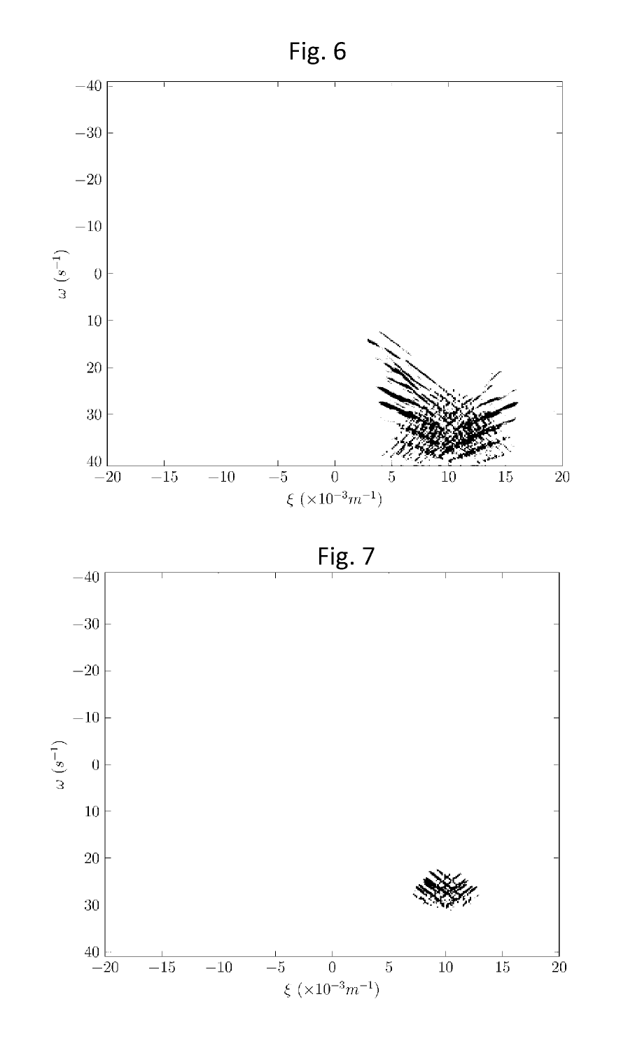

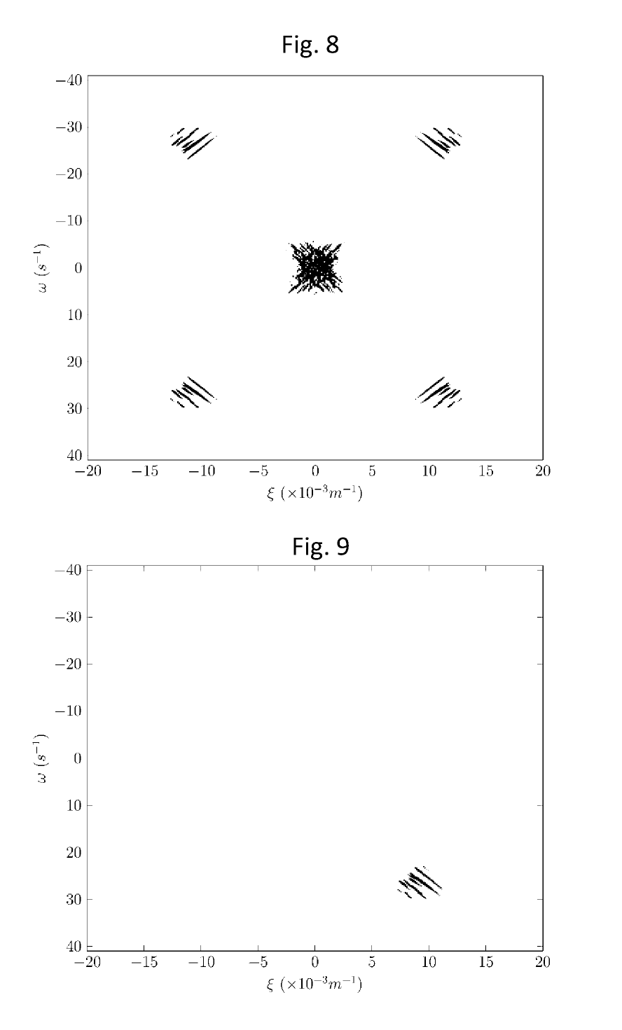

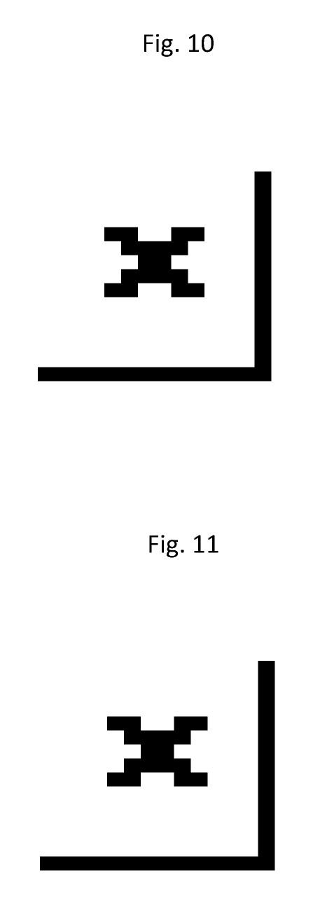

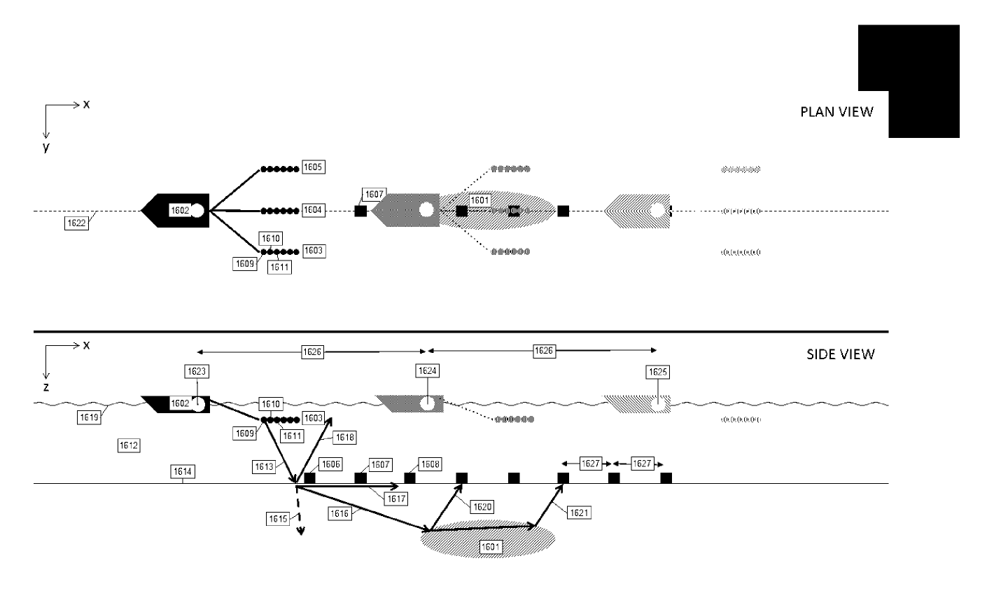

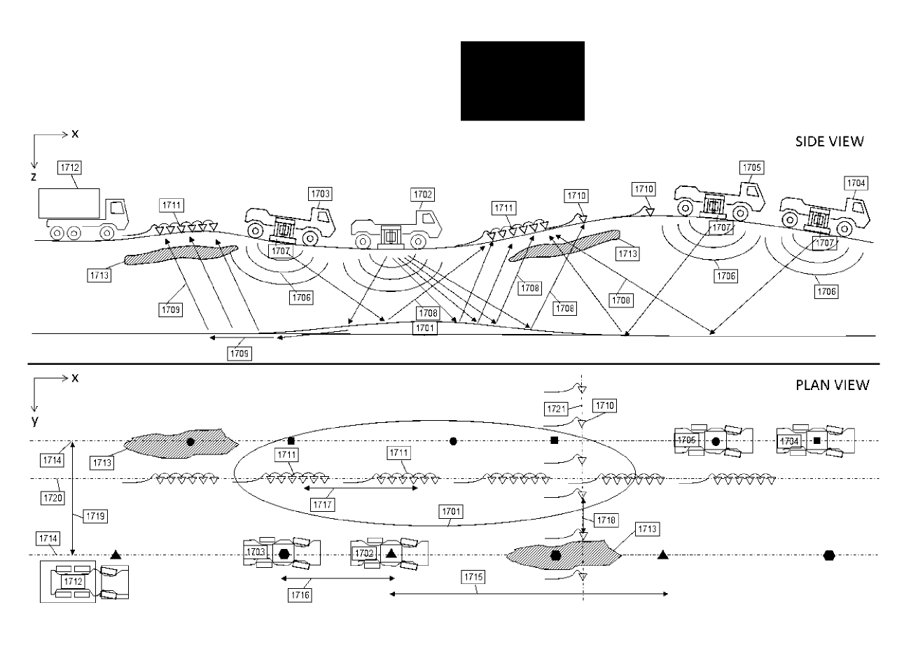

We now use the same example data set as in the previous example. In FIGS. 6-9 the procedure as well as some results are illustrated in the quaternion frequency domain. FIG. 6 shows the quaternion Fourier transform of the blended data. Note that there is only information in one of the quadrants. In FIG. 7 the blended data (outside the central diamond [symbol] ) is filtered by multiplication of ŵh from (5). Next, using the recovered parts of ƒ₁ and ƒ₂ we compute the quaternion phase functions using the filters from (6), and after that we apply the phase function multiplicatively in the (t,x)-domain using (4). In FIG. 8, the result is illustrated in the (ω,ξ)-domain. Finally, we isolate the two parts by multiplication from the left by p̅₁̅ and multiplication from the right by p̅₂̅. The final reconstruction is displayed in FIG. 9. In FIGS. 14-15 we illustrate the reconstruction in the temporal-spatial domain. FIG. 14 shows the reconstruction of source one by using the quaternion approach and FIG. 15 shows the corresponding reconstruction error.

The methods described herein have mainly been illustrated using so-called common receiver gathers, i.e., all seismograms recorded at a single receiver. Note however, that these methods can be applied straightforwardly over one or more receiver coordinates, to individual or multiple receiver-side wavenumbers. Processing in such multi-dimensional or higher-dimensional spaces can be utilized to reduce data ambiguity due to sampling limitations of the seismic signals.

We note that further advantages may derive from applying the current invention to three-dimensional shot grids instead of two-dimensional shot grids, where beyond the x- and y-locations of the simultaneous sources, the shot grids also extend in the vertical (z or depth) direction. Furthermore, the methods described herein could be applied to different two-dimensional shot grids, such as shot grids in the x-z plane or y-z plane. The vertical wavenumber is limited by the dispersion relation and hence the encoding and decoding can be applied similarly to 2D or 3D shotgrids which involve the z (depth) dimension, including by making typical assumptions in the dispersion relation.

The above discussion on separation over one more receiver coordinates also makes it clear that seismic apparition principles can be applied in conjunction with and/or during the imaging process: using one-way or two-way wavefield extrapolation methods one can extrapolate the recorded receiver wavefields back into the subsurface and separation using the apparition principles described herein can be applied after the receiver extrapolation. Alternatively, one could directly migrate the simultaneous source data (e.g., common receiver gathers) and the apparated part of the simultaneous sources will be radiated, and subsequently extrapolated, along aliased directions, which can be exploited for separation (e.g. by recording the wavefield not in a cone beneath the sources, but along the edges of the model).

As should be clear to one possessing ordinary skill in the art, the methods described herein apply to different types of wavefield signals recorded (simultaneously or non-simultaneously) using different types of sensors, including but not limited to; pressure and/or one or more components of the particle motion vector (where the motion can be: displacement, velocity, or acceleration) associated with compressional waves propagating in acoustic media and/or shear waves in elastic media. When multiple types of wavefield signals are recorded simultaneously and are or can be assumed (or processed) to be substantially co-located, we speak of so-called “multi-component” measurements and we may refer to the measurements corresponding to each of the different types as a “component”. Examples of multi-component measurements are the pressure and vertical component of particle velocity recorded by an ocean bottom cable or node-based seabed seismic sensor, the crossline and vertical component of particle acceleration recorded in a multi-sensor towed-marine seismic streamer, or the three component acceleration recorded by a microelectromechanical system (MEMS) sensor deployed e.g. in a land seismic survey.

The methods described herein can be applied to each of the measured components independently, or to two or more of the measured components jointly. Joint processing may involve processing vectorial or tensorial quantities representing or derived from the multi-component data and may be advantageous as additional features of the signals can be used in the separation. For example, it is well known in the art that particular combinations of types of measurements enable, by exploiting the physics of wave propagation, processing steps whereby e.g. the multi-component signal is separated into contributions propagating in different directions (e.g., wavefield separation), certain spurious reflected waves are eliminated (e.g., deghosting), or waves with a particular (non-linear) polarization are suppressed (e.g., polarization filtering). Thus, the methods described herein may be applied in conjunction with, simultaneously with, or after such processing of two or more of the multiple components.

Furthermore, in case the obtained wavefield signals consist of/comprise one or more components, then it is possible to derive local directional information (e.g. phase factors) from one or more of the components and to use this directional information in the reduction of aliasing effects in the separation as described herein in detail.

Further, it should be understood that the various features, aspects and functionality described in one or more of the individual embodiments are not limited in their applicability to the particular embodiment with which they are described, but instead can be applied, alone or in various combinations, to one or more of the other embodiments of the invention.

For example, it is understood that the techniques, methods and systems that are disclosed herein may be applied to all marine, seabed, borehole, land and transition zone seismic surveys, that includes planning, acquisition and processing. This includes for instance time-lapse seismic, permanent reservoir monitoring, VSP and reverse VSP, and instrumented borehole surveys (e.g. distributed acoustic sensing). Moreover, the techniques, methods and systems disclosed herein may also apply to non-seismic surveys that are based on wavefield data to obtain an image of the subsurface.

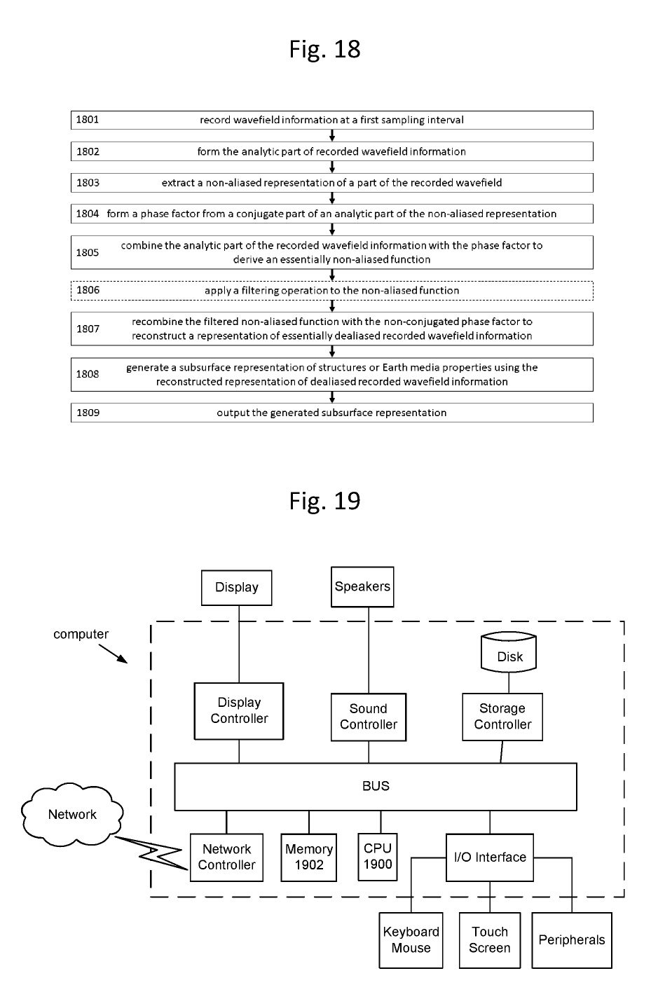

In FIG. 18, the key steps for one embodiment of the methods disclosed herein are summarized. In a first step, 1801, wavefield information is recorded at a first sampling interval. This is done in accordance with the general practice of marine or land seismic acquisition and/or the methods disclosed herein. In a second step, 1802, the analytic part is formed of the recorded wavefield information using the methods described herein (e.g., paragraphs [0046]-[0047] and/or [0073]-[0081]). In the third step, 1803, a non-aliased representation of a part of the recorded wavefield is extracted. Such representations are generally readily available at sufficiently low frequencies for typical chosen first sampling intervals. In a fourth step, 1804, a phase factor is formed from a conjugate part of an analytic part of the non-aliased representation using the method described herein (e.g., paragraphs [0050]-[0059]). In a fifth step, 1805, the analytic part of the recorded wavefield information is combined with the phase factor to derive an essentially non-aliased function (e.g., paragraphs [0059]-[0060] and [0061]). In a sixth step, 1806, which is optional, a filtering operation is applied to the non-aliased function, as described in paragraph [0060], to yield, e.g., a reconstruction at a higher resolution (i.e., spatial sampling rate) than the original data. In a seventh step, 1807, the filtered non-aliased function is recombined with the non-conjugated phase factor to reconstruct a representation of essentially dealiased recorded wavefield information (e.g., paragraph [0060]). In an eighth step, 1808, subsurface representations of structures or Earth media properties are generated using the reconstructed representation of dealiased recorded wavefield information. In a ninth step, 1809, the generated subsurface representations are output.

The methods described herein may be understood as a series of logical steps and (or grouped with) corresponding numerical calculations acting on suitable digital representations of the acquired seismic recordings, and hence can be implemented as computer programs or software comprising sequences of machine-readable instructions and compiled code, which, when executed on the computer produce the intended output in a suitable digital representation. More specifically, a computer program can comprise machine-readable instructions to perform the following tasks:

(1) Reading all or part of a suitable digital representation of the obtained wave field quantities into memory from a (local) storage medium (e.g., disk/tape), or from a (remote) network location;

(2) Repeatedly operating on the all or part of the digital representation of the obtained wave field quantities read into memory using a central processing unit (CPU), a (general purpose) graphical processing unit (GPU), or other suitable processor. As already mentioned, such operations may be of a logical nature or of an arithmetic (i.e., computational) nature. Typically the results of many intermediate operations are temporarily held in memory or, in case of memory intensive computations, stored on disk and used for subsequent operations; and

(3) Outputting all or part of a suitable digital representation of the results produced when there no further instructions to execute by transferring the results from memory to a (local) storage medium (e.g., disk/tape) or a (remote) network location.

Computer programs may run with or without user interaction, which takes place using input and output devices such as keyboards or a mouse and display. Users can influence the program execution based on intermediate results shown on the display or by entering suitable values for parameters that are required for the program execution. For example, in one embodiment, the user could be prompted to enter information about e.g., the average inline shot point interval or source spacing. Alternatively, such information could be extracted or computed from metadata that are routinely stored with the seismic data, including for example data stored in the so-called headers of each seismic trace.

Next, a hardware description of a computer or computers used to perform the functionality of the above-described exemplary embodiments is described with reference to FIG. 19. In FIG. 19, the computer includes a CPU 1900 (an example of “processing circuitry”) that performs the processes described above. The process data and instructions may be stored in memory 1902. These processes and instructions may also be stored on a storage medium disk such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which computer communicates, such as a server or another computer.

Further, the claimed advancements may be provided as a utility application, background daemon, or component of an operating system, or combination thereof, executing in conjunction with CPU 1900 and an operating system such as Microsoft Windows 10, UNIX, Solaris, LINUX, Apple MAC-OS and other systems known to those skilled in the art.

The hardware elements in order to achieve the computer can be realized by various circuitry elements, known to those skilled in the art. For example, CPU 1900 can be a Xenon or Core processor from Intel of America or an Opteron processor from AMD of America, or may be other processor types that would be recognized by one of ordinary skill in the art (for example so-called GPUs or GPGPUs). Alternatively, the CPU 1900 can be implemented on an FPGA, ASIC, PLD or using discrete logic circuits, as one of ordinary skill in the art would recognize. Further, C P U 1900 may be implemented as multiple processors cooperatively working in parallel to perform the instructions of the inventive processes described above.

### LIST OF CITED REFERENCES

[Abma et al., 2015] R. Abma, D. Howe, M. Foster, I. Ahmed, M. Tanis, Q. Zhang, A. Arogunmati and G. Alexander, Geophysics. 80, WD37 (2015).
[Andersson et al., 2016] Andersson, F., Eggenberger, K., van Manen, D. J., Robertsson, J., & Amundsen, L. (2016). Seismic apparition dealiasing using directionality regularization. In SEG Technical Program Expanded Abstracts 2016 (pp. 56-60). Society of Exploration Geophysicists.
[Akerberg et al., 2008] Akerberg, P., Hampson, G., Rickett, J., Martin, H., and Cole, J., 2008, Simultaneous source separation by sparse Radon transform: 78th Annual International Meeting, SEG, Expanded Abstracts, 2801-2805, doi:10.1190/1.3063927.
[Barnes, 1992] A. E. Barnes, GEOPHYSICS, 57(5), 749-751 (1992).
[Beasley et al., 1998] Beasley, C. J., Chambers, R. E., and Jiang, Z., 1998, A new look at simultaneous sources: 68th Annual International Meeting, SEG, Expanded Abstracts, 133-136.
[van der Blij, F. 1961] F. van der Blij, “History of the octaves.” Simon Stevin 34 1961: 106-125.
[Bracewell, 1999] R. Bracewell, The Fourier Transform & Its Applications (McGraw-Hill Science, 1999).
[Halliday et al., 2014] Halliday and Laws, Seismic acquisition using phase-shifted sweeps: US Patent application US20140278119A1 (2014).
[Hamilton, 1844] W. R. Hamilton, “Ii. on quaternions; or on a new system of imaginaries in algebra.” The London, Edinburgh, and Dublin Philosophical Magazine and Journal of Science 25.163: 10-13, (1844).
[Ikelle, 2010] L. T. Ikelle, Coding and Decoding: Seismic Data: The Concept of Multishooting. (Elsevier, 2010), Vol. 39.
[Kumar et al., 2015] R. Kumar, H. Wason and F. J. Herrmann, Geophysics. 80, WD73 (2015).
[Lynn et al., 1987] Lynn, W., Doyle, M., Larner, K., and Marschall, R., 1987, Experimental investigation of interference from other seismic crews: Geophysics, 52, 1501-1524.
[Moldoveanu et al., 2008] Moldoveanu, N., Kapoor, J., and Egan, M., 2008, Full-azimuth imaging using circular geometry acquisition: The Leading Edge, 27(7), 908-913. doi: 10.1190/1.2954032
[Mueller et al., 2015] M. B. Mueller, D. F. Halliday, D. J. van Manen and J. O. A. Robertsson, Geophysics. 80, V133 (2015).
[Robertsson et al., 2012] Robertsson, J. O. A., Halliday, D., van Manen, D. J., Vasconcelos, I., Laws, R., Özdemir, K., and Grønaas, H., 2012, Full-wavefield, towed-marine seismic acquisition and applications: 74th Conference and Exhibition, EAGE, Extended Abstracts.
[Robertsson et al., 2015] Robertsson, J. O. A., R. M. Laws, and J. E. Kragh, 2015, Marine seismic methods, in Resources in the near-surface Earth (eds. L. Slater and D. Bercovici), Treatise on Geophysics, 2^{nd} edition (ed. G. Schubert), Elsevier-Pergamon, Oxford.
[Robertsson et al., 2016] Robertsson, J. O. A., Amundsen, L., and Pedersen, A. S., 2016, Express Letter: Signal apparition for simultaneous source wavefield separation: Geophys. J. Int., 206(2), 1301-1305: doi: 10.1093/gji/ggw210.
[Robertsson et al., 2016b], Robertsson, J. O. A., Eggenberger, K., van Manen, D. J., and Andersson, F., 2016, Simultaneous source acquisition and separation method, GB Patent applications 1619037.3 filed on Nov. 10, 2016.
[Shipilova et al., 2016] Shipilova, E., Barone, I., Boelle, J. L., Giboli, M., Piazza, J. L., Hugonnet, P., and Dupinet, C., 2016, Simultaneous-source seismic acquisitions: do they allow reservoir characterization? A feasibility study with blended onshore real data: 86th Annual International Meeting, SEG, Expanded Abstracts.
[Smith, 1995]. J. D. H. Smith, “A left loop on the 15-sphere.” Journal of Algebra 176.1:128-138 (1995).
[Stefani et al., 2007] Stefani, J., Hampson, G., and Herkenhoff, E. F., 2007, Acquisition using simultaneous sources: 69th Annual International Conference and Exhibition, EAGE, Extended Abstracts, B006.
[Stockwell, 1996] R. G. Stockwell, L. Mansinha, and R. P. Lowe. Signal Processing, IEEE Transactions on 44(4), 998-1001 (1996).
[Ziolkowski, 1987] Ziolkowski, A. M., 1987, The determination of the far-field signature of an interacting array of marine seismic sources from near-field measurements: Results from the Delft Air Gun experiment: First Break, 5, 15-29.
[van Manen et al., 2016a] van Manen, D. J., Andersson, F., Robertsson, J. O. A., and Eggenberger, K., 2016, Source separation method: GB Patent Application No. 1603742.6 filed on 4 Mar. 2016.
[van Manen et al., 2016b] D. J. van Manen, F. Andersson, J. O. A. Robertsson, K. Eggenberger, 2016, De-aliased source separation method: GB patent application No. 1605161.7 filed on 28 Mar. 2016.

1. A method of dealiasing recorded wavefield information recorded at a first sampling interval, the method comprising:
forming an analytic part of the recorded wavefield information;
extracting a non-aliased representation of a portion of the recorded wavefield information;
forming a phase factor from a conjugate part of the analytic part of the non-aliased representation;
combining the analytic part of the recorded wavefield information with the phase factor to derive a non-aliased function;
applying a filtering operation to the derived non-aliased function;
recombining the filtered non-aliased function with the phase factor from the analytic part of the non-aliased representation to reconstruct a representation of dealiased recorded wavefield information;
generating a sub-surface representation of structures or Earth media properties from the reconstructed representation of the dealiased recorded wavefield information; and
outputting the generated sub-surface representation.

2. The method of claim 1, wherein the step of applying the filtering operation comprises resampling the derived non-aliased function at a second sampling interval that is smaller than the first sampling interval.

3. The method of claim 1, wherein aliasing in the recorded wavefield information is caused by interference of at least two interfering sources, and the step of applying the filtering operation to the derived non-aliased function comprises suppressing localized energy belonging to at least one of the at least two interfering sources.

4. The method of claim 1 wherein at least part of aliasing in the recorded wavefield information is caused by interference of at least two interfering sources, and the step of applying the filtering operation to the derived non-aliased function comprises resampling the derived non-aliased function at a second sampling interval that is smaller than the first sampling interval and suppressing localized energy belonging to at least one of the at least two interfering sources.

5. The method of claim 1, wherein the step of extracting the non-aliased representation includes suppressing high-frequency content of the recorded wavefield information.

6. The method of claim 1, wherein the step of forming the phase factor includes using a power of a conjugate of the phase factor of the non-aliased representation to extend the frequency range of the representation of the dealiased recorded wavefield information.

7. The method of claim 1, further comprising iteratively performing the forming, extracting, forming, combining, applying, and recombining steps to de-alias the wavefield information at increasingly higher frequencies.

8. The method of claim 1, further comprising filtering at least one or both of the phase factor and the recorded wavefield information using spatial and temporal filters that include wavefield structure information local in time and space, to reduce ambiguity in the phase factor due to directionality.

9. The method of claim 1, further comprising forming the analytic part using at least one of complex or hypercomplex number representations.

10. The method of claim 1, wherein the step of extracting the non-aliased representation is performed in one of a Fourier domain, a Radon domain, a parabolic Radon domain, a hyperbolic Radon domain, a Gabor domain, a wavelet domain, a curvelet domain, a Gaussian wave-packet domain, and another time-frequency-scale-orientation domain.

11. The method of claim 1, further comprising obtaining the wavefield information from at least two interfering sources.

12. The method of claim 11, wherein at least one of the at least two interfering sources has been encoded with a source modulation function to enable signal apparition.

13. The method of claim 9, wherein the step of forming the analytic part uses the hypercomplex number representations to convert a spatial aliasing into a temporal aliasing.

14. The method of claim 1, wherein the step of combining the analytic part of the recorded wavefield information with the phase factor reduces a frequency of an oscillatory part of the recorded wavefield.

15. The method of claim 1, wherein recorded wavefield information for multiple receivers are processed jointly in a multi-dimensional or higher-dimensional space where aliasing ambiguity is reduced.

16. The method of claim 1, further comprising seismic data processing steps, including migration or demultiple, for which the dealiasing allows for better data quality.

17. An apparatus for dealiasing recorded wavefield information recorded at a first sampling interval, the apparatus comprising:
processing circuitry configured to
form an analytic part of the recorded wavefield information;
extract a non-aliased representation of a portion of the recorded wavefield information;
form a phase factor from a conjugate part of the analytic part of the non-aliased representation;
combine the analytic part of the recorded wavefield information with the phase factor to derive a non-aliased function;
apply a filtering operation to the derived non-aliased function;
recombine the filtered non-aliased function with the phase factor from the analytic part of the non-aliased representation to reconstruct a representation of dealiased recorded wavefield information;
generate a sub-surface representation of structures or Earth media properties from the reconstructed representation of the dealiased recorded wavefield information; and
output the generated sub-surface representation.
